(19) United States
(12) Patent Application Publication
(10) Pub. No.: US 2012/0085783 A1
(43) Pub. Date: Apr. 12, 2012

(54) SYSTEM FOR FILLING LINERS

(76) Inventor: Stefan Schonert, Birmensdorf (CH)

(21) Appl. No.: 13/377,798

(22) PCT Filed: May 28, 2010
(86) PCT No.: PCT/CH10/00142

§ 371 Date: Dec. 12, 2011

(30) Foreign Application Priority Data
Jun. 11, 2009 (CH) 905/09

(51) Int. Cl. B67D 1/00; B67D 7/78; B67D 7/70

(52) U.S. Cl. 222/135; 222/57; 222/145.5

(57) ABSTRACT

An apparatus for impregnating liners with epoxy resin and the curing agents therefor includes an epoxy resin tank having a first discharge pipe with a first pump and a curing agent tank having a second discharge pipe with a second pump. Each discharge pipe leads through a flowmeter device. A control unit processes signals from the flowmeter devices with the amount of resin flow used being a control variable. The control unit, where the desired mixing ratio can be set as a parameter, sets or readjusts the pump for the curing agent tank to a precise amount of curing agent needed. A three-way valve is included in each of the epoxy resin and curing agent discharge pipes downstream from the pumps and the flowmeter devices. From each three-way valve, a conduit leads back into a corresponding tank and a further conduit leads to the mixing nozzle. Refill conduits, each having a valve, lead to a corresponding discharge pipe, so that the apparatus can refill itself

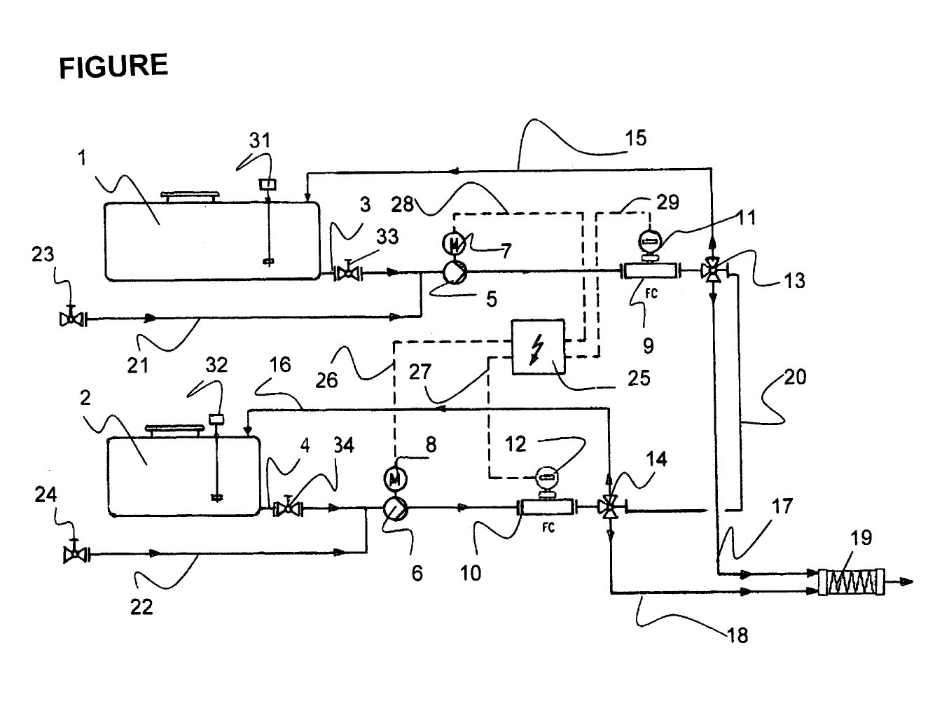

This invention relates to a system for the filling of liners with epoxy resin and its hardener for the subsequent impregnation. The system is designed, as a specialty, as a combined system, which allows the mixing, the filling and the circulation of resin and hardener in a circuit as it is needed.

The method according to which a pipe or a sewer pipe is repaired using a liner, has been known for many years and is practiced more often because it is cost-saving and road ditches must not be opened. In principle, a hose made of a needle punched non-woven or of glass or polyester fibers is introduced into a damaged pipe. The hose material is first impregnated with a suitable resin in that the said hose is, for example, pulled through a bath or the resin is pumped through holes into the hose which is coated on the external side an impermeable film; the said hose being drawn afterwards through a calibration cylinder. For this purpose, the hose is cut on its upper side in the longitudinal direction over a few cm to form a slit and a nozzle is inserted through this slit into the interior of the hose; the said nozzle being mounted on a front end of a pumping hose and the said nozzle protruding into hose in the opposite conveying direction. A mixture of resin and hardener is pumped by means of this nozzle into the interior of the hose. A bulge results from the pumping of the resin-mixture into the liner and thus a lump consisting of the hardener and resin-mixture is formed in the interior of the hose. The nozzle is retracted and the slit is sealed with an adhesive tape. The hose with the bulge then moves to the inlet of the calibration cylinder, is pulled between the cylinders, whereby the resin is pressed deeply into the porous inner material of the hose. The deep and continuous, uniform impregnation of the porous material into the interior of the hose is of crucial importance for the future stability of the cured liner.

The resin and hardener are stored prior to mixing and pumping into the tube in separate tanks. If the resin mixture must to be pumped into the liner hose, the resin must then be mixed in the correct ratio with the hardener which takes place in a static mixer inside into the pumping nozzle. From there, the final resin-hardener mixture passes into the tube, where it is then incorporated into the tube with a calibration cylinder.

Some conventional systems work with pneumatic lift cylinders which supply the individual components batchwise, or the components are conveyed by means of a screw pump. It is not possible to realize the mixing continuously but always batchwise. On the other hand, the drawback of using screw pumps is that the screw pumps jam and dose with unsatisfactory accuracy. The flow volume of both components is measured and the required mixing ratio and the required amount are adjusted. These pump parameters, now adjusted, are then fixed values which helps to determine the amount of resin, on one hand and the amount of the hardener, on the other hand, independently from each other. If the viscosity of the resin or the hardener is modified or a valve is not correctly open or closed, or in case of friction loss, or if a valve in a pipe is dirty, etc., then each pump is pumping regardless of this friction or dirt by means of adjusted parameters like the rotation speed or wing position, although the mixing ratio between the resin and the hardener is modified. For these reasons, it may happen that a liner is provided unnoticed with an incorrect or non-optimal mixing ratio between the resin and the hardener and the liner is inserted in inserted in the pipe in this state. At the end, you have, for example, in the middle of a 60 m long repaired pipe several meters of low quality, which cannot be removed! The system detects that the mixing ratio is no more accurate and can at best turn off the mixer. Afterwards, the operator must reset manually the correct values, such as viscosity, pressure drop, etc. until the mixing ratio corresponds to the required value. Another drawback is that s the conventional systems require additional separate pumps for the filling of storage tanks, that is for the filling of the epoxy resin as well as the hardener. Hoses must be suspended for the filling and separate equipment is generally required.

It is therefore the object of the present invention to realize a system for the impregnation of liners with epoxy resin and its hardeners which is simpler compared to the system of the state of the art, with a minimum of maintenance and which keeps automatically and exactly either determined target values of resin and hardeners or a determined mixing ratio of resin and hardeners dynamically at each time on a very narrow bandwidth. In a particular embodiment, the system should be able to refill automatically without the need of an external pump.

This object is solved by means of a system for the impregnation of liners with epoxy resin and its hardeners as blending components characterized by the features of claim 1.

In a particular embodiment, the system is characterized according to the preamble in that a filling pipe having a stop valve for the filling of the tanks leads into the corresponding drain pipes, so that the pumps can be used optionally for the automatic filling of the system.

The pumps are adjusted directly by the control unit which is coupled to the flow measuring system of the correct mixing ratio of resin and hardener. That means: If one of the values differs from the target value, regardless from which target value it differs, from the resin value or from the hardener value, the corresponding pump is then reset in order to maintain always the same exact mixing ratio. The system also guarantees quality in that it demonstrates what is pumped exactly when, where and with which parameters into a liner. In a particular embodiment, the system can automatically fill its own associated tanks for the resin and the hardener with the existing delivery and mixing pumps by means of an additional filling pipe having a coupling and a valve. The function of the existing pumps will be also extended to the filling of resin and hardener tanks without external pumps.

The system is described below with reference to a schematic representation of the figure and its function is explained.

The system includes two tanks 1, 2. A first tank 1 contains an epoxy resin, a second tank 2 contains a hardener. A drain pipe 3, 4 having a valve 33, 34, for example, in form of a stop valve or a non-return valve leads from the two tanks 1, 2 and each drain pipe 3, 4 leads through a pump 5, 6. These pumps are in the shown example, gear pumps, but this is not mandatory. Alternatively, piston pumps can, for example, also be used which pump lift can be adjusted to control the conveying power via a driving device, for example, a servo motor. Gear pumps offer the advantage that they basically consist of only three components, namely a housing with inlet and outlet as well as two gears from which at least one is driven. In the external gear pump with evolvent toothing, the medium to be delivered is transported into the spaces between teeth and the housing. The pump is robust because of this simple construction and cost saving and has the great advantage that the construction cannot rigidify, even if it was not long in operation. The gear pumps used here are each driven by an electronically controlled electric motor 7, 8.

As shown above, after the exit of the drain pipes 3, 4 out of these gear pumps 5, 6, the pipes 3, 4 are guided each through a flow meter 9, 10. It can be a volume flow meter or a mass flow meter. In the case of mass flow meters 9, 10 it can be a Coriolis mass flow meter (CMD) because these are very precise. On these here incorporated mass flow meters are placed display units 11, 12, so that each flow can be immediately read. The data is transmitted over the electrical lines 27, 29 to a central control unit 25 for processing. This control unit 25 is coupled to the motors 7, 8 of the pumps, here the gear pumps 5, 6. Thus, these motors 7, 8 can be controlled according to the flow measurements.

Mixing ratios between the resin and the hardener can be programmed very precisely by means of the control unit 25. In each case, the mass flow of a mixed component serves as a reference value for the mass flow value of the second component, regardless of whether the resin or the hardener is treated as a first mixing component. The reference value and the corresponding pump power are the master, while the pump is the slave of the second mixing component. The mass flow of the hardener, for example, which is to be mixed at a determined flow value of the resin is calculated by the control unit and must be strictly respected. In case of deviations detected from the beginning by the control unit via the flow measuring systems, the said control unit leads the pump via the periodic or dynamic adaptation of the rotation speed or other determined parameter for the conveyance power to the optimal mixing value. A list of the mixing ratios is established at the same time as the masses for the two components which masses are effectively conveyed in real time. This list can be processed electronically and can be printed afterwards if necessary. A quality seal can thus be established any time for the resin/hardener mixture which is pumped into a liner.

Beyond the Pumps 5, 6, and optionally in front of or behind the mass flow meter 9, 10 of the two pipes 3, 4 for the resin and the hardener, these pipes are each guided into a three-way valve 13, 14 or into a valve arrangement which acts as a three-way valve, whereby one path leads out of the three-way valves 13, 14 or out of the valve device into the pipes 17, 18 and whereby these pipes lead into a mixing nozzle 19. The two matched components are effectively here mixed and afterwards, the mixture is introduced into the liner. The two other pipes 15, 16 are guided back from these three-way valves 13, 14 or the valve arrangement into the corresponding component tanks 1, 2. The tanks 1, 2 are equipped with level measuring sensors 31, 32, and the measuring signals can also be transferred to the control unit 25. The two three-way valves 13, 14 are coupled to a control line 20, or the said in case of a valve arrangement which acts as a three-way valve, the said arrangement is coupled to a control line 20. In a particular embodiment of the system as shown in the figure, a supply pipe 21 having a stop valve 23 is guided into the drain pipe 3 of the tank 1 for the resin, and a similar supply pipe 22 having a stop valve 24 is guided into the tank 2 for the hardener.

The system now allows different operating conditions. The three-way valves 13, 14 or the valve arrangement which acts as a three-way valve are adjusted so that the two components are pumped via the return pipes 15, 16 back into the corresponding tanks 1, 2, i.e., the two components circulate into the circuit in order to open the valves 33, 34 for preparing the pumping of the two components into the mixing valve 19 and in order to adjust initially the three-way valves 13, 14 or the valve arrangement which acts as a three-way valve. Then, the mixing ratio and the mass flow are introduced into the control device a parameters. This can also be realized before the pumps 5, 6 operate. The mass flow or the volume flow of the resin are used as reference values and the control unit 25 calculates a determined associated flow value for the hardener and the pump 6 is automatically adjusted to the associated conveying power. If the mass flow or the volume flow of the resin or the hardener are modified by any influence, this is immediately detected by the control unit 25 which readjusts the pump of the respective second component so that the mixing ratio moves in a constant manner in a very narrow band width. It is possible to operate the system in a circulation modus almost “dry” without realizing effectively the mixing and it is possible to measure and to verify exactly the mixing ratio. The components are already conveyed and circulate in a corresponding manner in a closed circuit with a perfect mixing ratio which can be verified and with a pre-selected mass velocity. The two three-way valves 13, 14 or the valve arrangement which acts as a three-way valve are simultaneously switched when a mixing is desired, in order to convey the components into the pipes 17, 18 and thus into the mixing nozzle 19.

The system is automatically stopped before the components are missing as soon as the level measuring level indicates that the tank contents are running low. Generally, the system is automatically stopped by the control unit 25 or switched on the circulation modus when the flow measuring, i.e. a mass flow measurement or a volume flow measurement detects during a chosen period of time a deviation from the adjustable band width of the target values and this deviation is sent to the control unit 25. If necessary, the system can fill its tanks itself. For this purpose, the three-way valves 13, 14 or the valve arrangement which acts as a three-way valve are switched on the modus internal circulation. Once the filling hoses of the delivered tanks or containers are coupled to the stop valves 23, 24, the stop valves 23, 24 are open. Now, the pumps 5, 6 can be operated. So the said pumps suck the components out of the delivered tanks or the delivered container and pump the contents of these tanks or containers into the tanks 1, 2 of the device. Once the level sensors measure a determined adjustable maximum degree of filling, then the device is automatically stopped by the control unit 25 to avoid an overfilling of the tanks. In this way, the two tanks 1, 2 can be individually filled being controlled by the control unit 25. If the tanks 1, 2 are filled, the stop valves 23, 24 can be operated in order to mix as desired.

1-12. (canceled)

13. An apparatus for impregnating liners with epoxy resin and a hardener as mixing components, comprising:
an epoxy resin tank having a first discharge pipe with a first pump, said first discharge pipe having a first flowmeter and further including a first three-way valve therein for resin, a first return pipe leading back to said epoxy resin tank and a first additional pipe leading to a mixing nozzle;
a hardener tank having a second discharge pipe with a second pump, said second discharge pipe having a second flowmeter and further including a second three-way valve therein for hardener, a second return pipe leading back to said hardener tank and a second additional pipe leading to said mixing nozzle;
a control unit for processing signals from said first flowmeter and said second flowmeter and for controlling at least one of said first pump and said second pump, so that a mixing ratio of epoxy resin and a hardener as mixing components is automatically controllable, wherein a flow rate of a first mixing component from said control unit is used as a reference value for said second mixing component, and conveying power of at least one of said first pump and said second pump is adjustable to said mixing ratio that is predetermined for a respective said first mixing component or said second mixing component via said control unit.

14. The apparatus for impregnating liners with epoxy resin and a hardener as mixing components according to claim 13, wherein said first pump and said second pump are gear pumps and each of said gear pumps is driven via a dedicated electromotor.

15. The apparatus for impregnating liners with epoxy resin and a hardener as mixing components according to claim 14, wherein at least one said dedicated electromotor is controllable via a dedicated frequency transformer by said control unit.

16. The apparatus for impregnating liners with epoxy resin and a hardener as mixing components according to claim 14, wherein each said dedicated electromotor is independently controlled via a dedicated frequency transformer by either said control unit or an additional and dedicated control unit.

17. The apparatus for impregnating liners with epoxy resin and a hardener as mixing components according to claim 13, wherein said first flowmeter and said second flowmeter are each Coriolis flowmeters for measuring flow masses of liquid according to the Coriolis Principle.

18. The apparatus for impregnating liners with epoxy resin and a hardener as mixing components according to claim 13, wherein said epoxy resin tank has a first measuring sensor and said hardener tank has a second measuring sensor, respectively for determining a liquid level of said epoxy resin tank and said hardener tank with said first measuring sensor and said second measuring sensor being capable of supplying a signal to said control unit, so that said first pump and said second pump are able to be automatically stopped when a predetermined filling level for each of said epoxy resin tank and said hardener tank has been attained.

19. The apparatus for impregnating liners with epoxy resin and a hardener as mixing components according to claim 13, wherein said first pump and said second pump are piston pumps with each of said piston pumps having a piston lift adjustable for controlling the conveying power of at least one of said first pump and said second pump.

20. An apparatus for impregnating liners with epoxy resin and a hardener as mixing components, comprising:
an epoxy resin tank having a first discharge pipe with a first pump, said first discharge pipe having a first flowmeter and further including a first three-way valve therein for resin, a first return pipe leading back to said epoxy resin tank and a first additional pipe leading to a mixing nozzle;
a hardener tank having a second discharge pipe with a second pump, said second discharge pipe having a second flowmeter and further including a second three-way valve therein for hardener, a second return pipe leading back to said hardener tank and a second additional pipe leading to said mixing nozzle;
a control unit for processing signals from said first flowmeter and said second flowmeter and for controlling at least one of said first pump and said second pump, so that a mixing ratio of epoxy resin and a hardener as mixing components is automatically controllable, wherein flowing values of said mixing components are independently utilized as target values able to be set by said control unit by controlling conveying power of each of said first pump and said second pump and with said flowing values being stopped when variations of actual flowing values exceed the target values.

21. The apparatus for impregnating liners with epoxy resin and a hardener as mixing components according to claim 20, wherein said first pump and said second pump are gear pumps and each of said gear pumps is driven via a dedicated electromotor.

22. The apparatus for impregnating liners with epoxy resin and a hardener as mixing components according to claim 21, wherein at least one said dedicated electromotor is controllable via a dedicated frequency transformer by said control unit.

23. The apparatus for impregnating liners with epoxy resin and a hardener as mixing components according to claim 21, wherein each said dedicated electromotor is independently controlled via a dedicated frequency transformer by either said control unit or an additional and dedicated control unit.

24. The apparatus for impregnating liners with epoxy resin and a hardener as mixing components according to claim 20, wherein said first flowmeter and said second flowmeter are each Coriolis flowmeters for measuring flow masses of liquid according to the Coriolis Principle.

25. The apparatus for impregnating liners with epoxy resin and a hardener as mixing components according to claim 20, wherein said epoxy resin tank has a first measuring sensor and said hardener tank has a second measuring sensor, respectively for determining a liquid level of said epoxy resin tank and said hardener tank with said first measuring sensor and said second measuring sensor being capable of supplying a signal to said control unit, so that said first pump and said second pump are able to be automatically stopped when a predetermined filling level for each of said epoxy resin tank and said hardener tank has been attained.

26. The apparatus for impregnating liners with epoxy resin and a hardener as mixing components according to claim 20, wherein said first pump and said second pump are piston pumps with each of said piston pumps having a piston lift adjustable for controlling the conveying power of at least one of said first pump and said second pump.

27. An apparatus for impregnating liners with epoxy resin and a hardener, comprising:
an epoxy resin tank having a first discharge pipe with a first pump, said first discharge pipe having a first flowmeter and further including a first three-way valve therein for resin, a first return pipe leading back to said epoxy resin tank and a first additional pipe leading to a mixing nozzle;
a hardener tank having a second discharge pipe with a second pump, said second discharge pipe having a second flowmeter and further including a second three-way valve therein for hardener, a second return pipe leading back to said hardener tank and a second additional pipe leading to said mixing nozzle;
a first supply pipe having a first value for said epoxy resin tank leading to said first discharge pipe for supplying said epoxy resin tank so that said first pump is optionally able to supply said apparatus; and,
a second supply pipe having a second valve for said hardener tank leading to said second discharge pipe for supplying said hardener tank so that said second pump is optionally able to supply said apparatus.

28. The apparatus for impregnating liners with epoxy resin and a hardener according to claim 27, wherein said first pump and said second pump are gear pumps and each of said gear pumps is driven via a dedicated electromotor.

29. The apparatus for impregnating liners with epoxy resin and a hardener according to claim 28, wherein at least one said dedicated electromotor is controllable via a dedicated frequency transformer.

30. The apparatus for impregnating liners with epoxy resin and a hardener as mixing components according to claim 27, wherein said first flowmeter and said second flowmeter are each Coriolis flowmeters for measuring flow masses of liquid according to the Coriolis Principle.

31. The apparatus for impregnating liners with epoxy resin and a hardener as mixing components according to claim 17, wherein said epoxy resin tank has a first measuring sensor and said hardener tank has a second measuring sensor, respectively for determining a liquid level of said epoxy resin tank and said hardener tank with said first measuring sensor and said second measuring sensor being capable of supplying a signal to a control unit, so that said first pump and said second pump are able to be automatically stopped when a predetermined filling level for each of said epoxy resin tank and said hardener tank has been attained.

32. The apparatus for impregnating liners with epoxy resin and a hardener as mixing components according to claim 27, wherein said first pump and said second pump are piston pumps with each of said piston pumps having a piston lift adjustable for controlling conveying power of at least one of said first pump and said second pump.
